(19) United States
(12) Patent Application Publication
(10) Pub. No.: US 2004/0166722 A1
(43) Pub. Date: Aug. 26, 2004

(54) Spring-biased connector mounting assembly

(75) Inventor: Jim Kennedy, Rock Hill, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Kings Electronics Co., Inc.

(21) Appl. No.: 10/374,697

(22) Filed: Feb. 25, 2003

(51) Int. Cl. H01R 13/58

(52) U.S. Cl. 439/470

(57) ABSTRACT

A connector mounting assembly for receiving and holding a connector at an end of a conducting cable. The connector assembly includes a support member and a spring-biased device, wherein the spring-biased device is spaced opposite from the support member a sufficient distance to receive the connector therebetween. Advantageously, the spring-biased device urges the connector against the support member so as to retain the connector without the use of separate fasteners or screws. In another aspect, the connector assembly may include a retaining member that is also spaced opposite the spring-biased device and includes a retaining edge that extends between a pair of shoulders of the connector so as to restrain axial motion of the connector. The connector mounting assembly is particularly suited to securing bulky and heavy connectors at the end of triaxial telecommunications cables.

### BACKGROUND OF THE INVENTION

1. Field of the Invention

The present invention involves the use of connector mounting assemblies, and in particular, connector mounting assemblies for connectors at the end of conducting cables.

2. Description of Related Art

Due to the need to transport and interchange connections between various types of electronic devices, conducting cables that supply power to, or provide a signal pathway to and from, the electronic devices must have connectors on their ends. Such connectors ensure that the ends of the cables are secured to each other even during movement of the electronic devices, and also ensure proper alignment of the conducting elements of the cables for a clear signal. Cables are not limited to single conducting elements, but may also include multiple conducting elements, such as coaxial and triaxial cables. Coaxial cables are frequently used to supply subscription-based television programming in residential areas and include a center and peripheral conducting elements, as is well-known in the art. Triaxial cables include three conducting elements, one center conducting element and two concentrically spaced conducting elements that surround the center conducting element. Triaxial cables are relatively thick and heavy, and are employed in commercial grade television cameras and video processing equipment.

Generally, the size, weight and complexity of connectors at the ends of such cables increases with the number of conducting elements in the cables. In addition, the number of cables, and subsequently the number of connectors, employed in commercial uses can be quite large. Mounting panels and bulkheads are frequently employed to ensure orderly connection of large numbers of cables, and are especially useful for the bulky, heavy connectors at the ends of triaxial cables.

For instance, U.S. Pat. Nos. 6,146,192 and 6,231,380 to Cabalka et al. (collectively “the Cabalka patents”) disclose a bulkhead connector system. As shown in FIG. 1 of the Cabalka patents, the bulkhead 20 includes a plurality of connection locations 22 that permit connection of a female or male connector 26, 28 of a triaxial telecommunications cable 23. The connectors are each mounted to an angled mounting plate 36 or a vertical mounting plate 38 by a female yoke 58 or a male yoke 58′. Each yoke includes two yoke halves 140 defining a central opening for receiving one of the connectors, as shown in FIG. 12 of the Cabalka patents. The yoke halves include openings 146 for receiving fasteners 108 that mount the yoke halves to one of the mounting plates. In addition, the yoke halves have openings 153 on their sides for receiving fasteners 160 that join the halves together about the connector. In this manner, the yoke is secured around the connector, and the yoke and connector are secured to the mounting plate of the bulkhead. Despite securing the connector to the mounting plate however, the steps of securing the yoke around the connector and the mounting plate are somewhat cumbersome due to the need to insert and tighten a large number of screws or fasteners.

Therefore, it would be advantageous to have a connector mounting system for securely mounting a connector to a panel or bulkhead that does not involve the use of yokes or a large number of fasteners. In addition, it would be advantageous if the connector mounting system allowed for mounting of the relatively large and heavy connectors, such as the connectors used on the ends of triaxial cables.

### BRIEF SUMMARY OF THE INVENTION

The present invention addresses the above needs and achieves other advantages by providing a connector mounting assembly for receiving and holding a connector at an end of a conducting cable. The connector mounting assembly includes a support member and a spring-biased device, wherein the spring-biased device is spaced opposite from the support member a sufficient distance to receive the connector therebetween. Advantageously, the spring-biased device urges the connector against the support member so as to retain the connector without the use of separate fasteners or screws. In another aspect, the connector assembly may include a retaining member that is also spaced opposite the spring-biased device and includes a retaining edge configured to extend between a pair of shoulders of the connector so as to restrain axial motion of the connector. The connector mounting assembly is particularly suited to securing bulky and heavy connectors at the end of triaxial telecommunications cables.

In one embodiment, the present invention includes a connector mounting assembly for receiving and holding a connector at the end of a conducting cable, such as a triaxial conducting cable, wherein the connector has an outer surface. Defining at least one support surface is a support member of the assembly wherein the support surface is configured to abut the outer surface of the connector. A spring biased member defines a spring-biased surface positioned opposite the support surface of the support member. The spring-biased surface is spaced a sufficient distance from the support member to allow the connector to pass between the support and spring biased members. Further, the spring-biased surface is configured to urge the connector against the support surface so as to firmly hold the connector between the members.

Optionally, the connector mounting assembly may also include a retaining member defining a retaining edge configured to abut a shoulder, or extend between a pair of shoulders, of the connector. Similar to the support member, the retaining member is positioned opposite the spring-biased device to allow the connector to pass therebetween. Such positioning allows the spring-biased surface of the spring-biased device to urge the connector against the retaining member with the retaining edge abutting the shoulder of the connector and thereby restraining axial motion of the connector. Preferably, the retaining member is spaced from the support member in an axial direction with respect to the connector so as to provide more stable longitudinal support for the connector.

In another aspect, the support member includes a support plate having a front and back faces, and an opening extending between the front and back faces. The opening is partially defined by the support surface. In the case of a support plate defining a circular opening sized and shaped to receive a cylindrical triaxial connector, the support surface is an arc-portion of an edge of the plate defining the opening that is opposite the spring-biased device and against which the connector is urged by the spring-biased device. Optionally, the retaining member may be fixed to, and extend from, the back face of the support plate, such as when the support member and retaining member are integrally formed of a single piece of material. Additional openings may be defined by the support plate to allow its attachment to a bulkhead or panel.

The spring-biased device may be a cantilever spring having a fixed end and configured to extend from the fixed end along the connector to a free end. Preferably, the cantilever spring-biased device defines the spring-biased surface as a surface at least partially congruent to a right-cylindrical surface of the connector. The fixed end may be directly fixed to the support member so as to be fixed with respect to the support surface. Fixation may be by overmolding the end of the cantilever spring-biased device into the support plate. The fixed end may be further secured via connector studs transfixing the spring-biased device and which are also overmolded.

The cantilever spring maybe constructed of various resilient materials, such as a ribbon of resilient steel that extends in an arc from the fixed end to the free end. In such an arrangement, the spring-biased surface defines an elliptical opening in the arcing ribbon that is congruent with the outer surface of a connector having a right-cylindrical shape.

The present invention has many advantages. For instance, the connector mounting assembly is easy and quick to use because the spring clip is retractable to allow insertion and removal of the connectors without the removal and reattachment of fasteners. The retaining member limits axial movement of the connectors via the retaining edge being adjacent the shoulder of the groove on the connectors. Also, the retaining member provides additional support through its base portion support surface which abuts the connector outer surface along with the support surface of the connector plate. The congruent, circular shape of the connector opening further restricts movement of the connector through increased surface area contact with the right cylindrical surface of the connector. Also, the portion of the surface on the same side of the connector as the spring clip inhibits tilting of the connector under the application of the spring bias. Overmolding the fixed end of the spring clip, and the use of connector studs, provides a secure connection of the spring clip to the connector plate. The length of the elliptical opening provides a relatively elongate spring-biased surface for firm, abutting support of the connector against the retaining member and the support surfaces.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a connector mounting panel assembly of one embodiment of the present invention;

FIG. 2 is a cross-sectional view of one of a plurality of male triaxial cable connectors shown supported in the mounting panel assembly of FIG. 1;

FIG. 3 is a cross-sectional view of one of a plurality of female triaxial cable connectors shown supported in the mounting panel assembly of FIG. 1;

FIG. 4 is a perspective view of a spring-biased connector mounting assembly of another embodiment of the present invention including a connector mounting plate supported directly on a bulkhead and supporting a male triaxial cable connector;

FIG. 5 is a perspective view of a pair of spring-biased connector mounting assemblies of another embodiment of the present invention supporting male and female triaxial cable connectors;

FIG. 6 is a perspective view of a connector mounting plate, retaining member and spring clip of each of the connector mounting assemblies shown in FIG. 5;

FIG. 7 is an enlarged fragmentary perspective view of a connector mounting plate, retaining member and spring clip of each of the connector mounting assemblies shown in FIG. 6.

### DETAILED DESCRIPTION OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

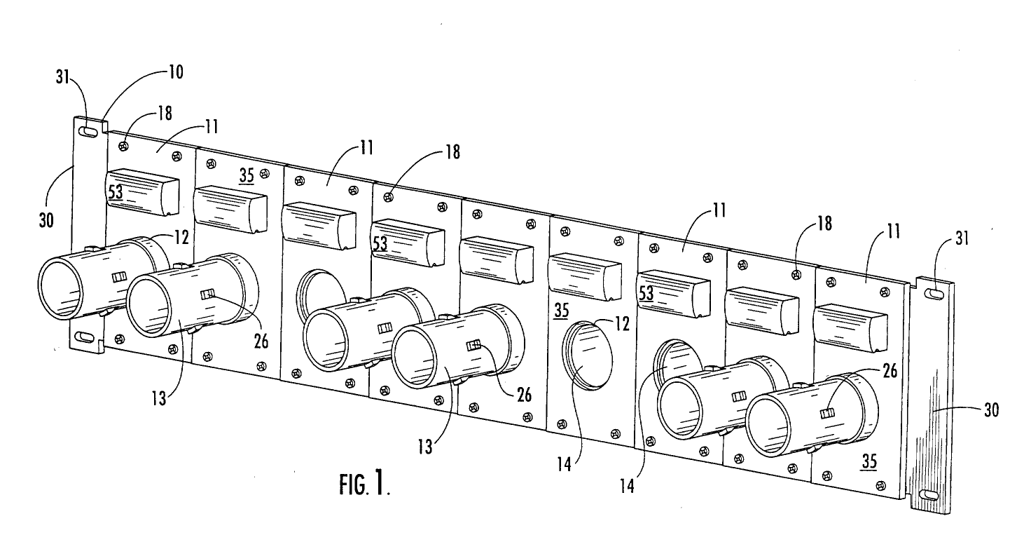

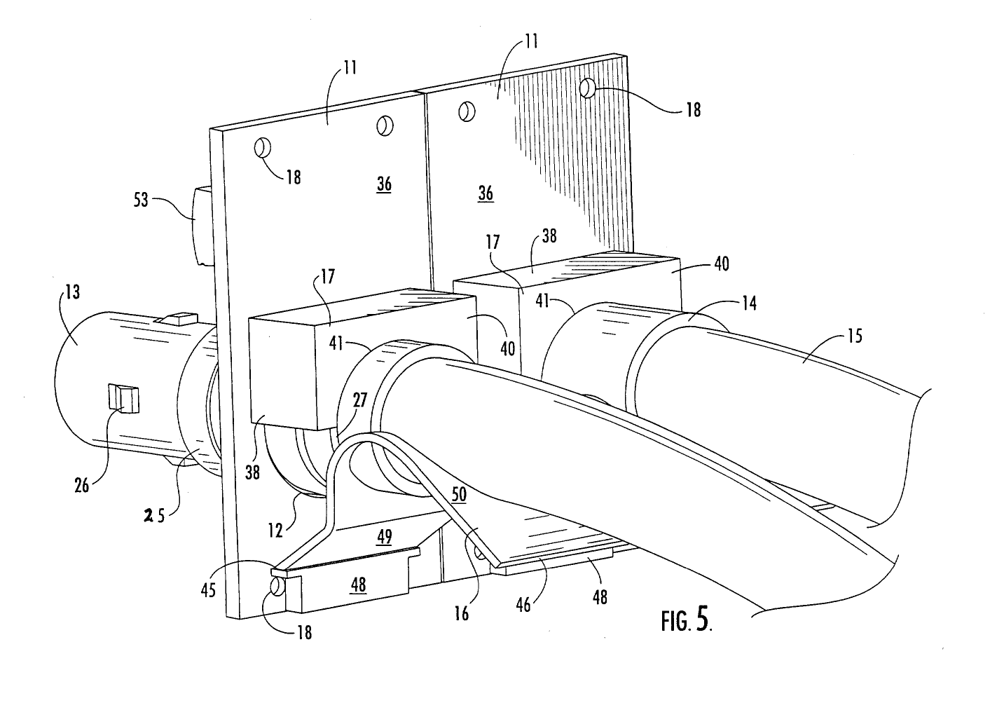

In one embodiment, the present invention includes a connector mounting panel 10 defining a plurality of mounting locations wherein each location is configured for mounting of a connector plate 11, as shown in FIG. 1. Each connector plate defines a connector opening 12 for receiving a male connector 13, or a female connector 14, at the end of a conducting cable 15. The male or female connector 13, 14 is secured within the opening the connector plate 11 by a spring clip 16 and a retaining member 17 (as seen in FIGS. 5, 6 and 7).

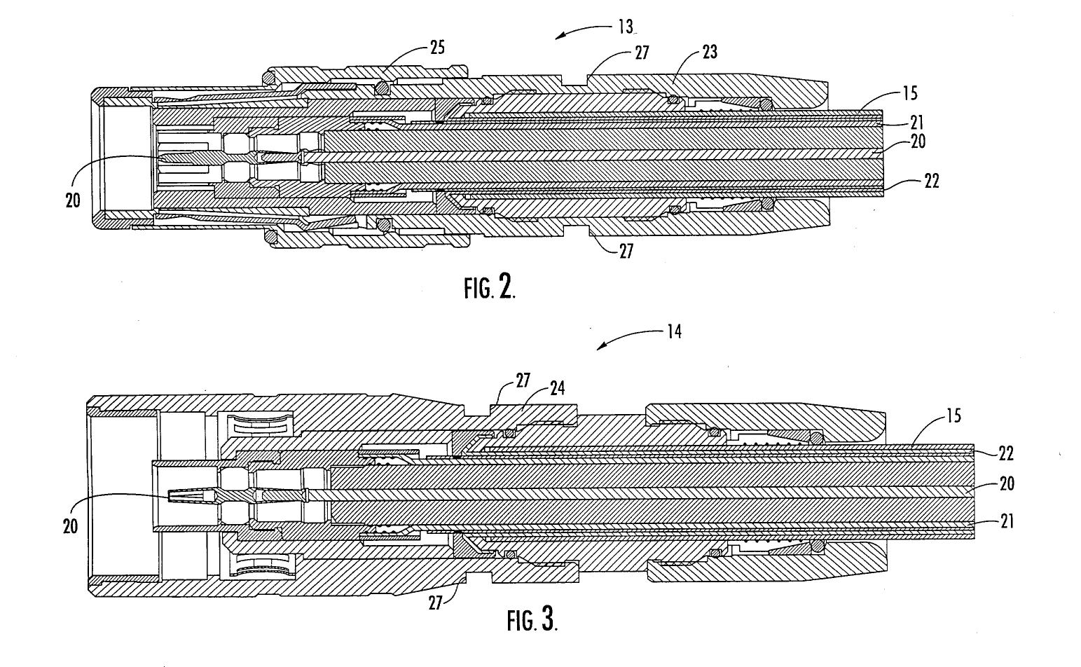

Preferably, the male and female connectors 13, 14 are triaxial-type connectors each at the end of a respective triaxial-type conducting cable 15. The connectors 13, 14 each include a center conductor 20, a first coaxial conductor 21 and a second coaxial conductor 22, as shown in FIGS. 2 and 3. The male connector 13 has a male body 23 that is cylindrical in shape and includes a sliding sleeve 25 (as seen in FIGS. 1, 4 and 5) that controls the extension and retraction of a set of circumferentially spaced latching clips 26 that secure it within the female connector 13. The female connector 13 also has a cylindrically shaped female body 24 that is slightly larger in diameter than the male body 23 so as to be capable of receiving the male body within its open end. Although support of triaxial connectors is discussed and illustrated herein, the connector mounting assembly of the present invention may also be used to support other types of connectors, such as coaxial or fiber-optic cable connectors, or conduit or piping for holding the same.

The connector mounting panel 10 is constructed of a rectangular strip of sheet material that is elongate in the width-wise direction and has the mounting locations regularly spaced along its width. Each mounting location includes a group of four fastener openings positioned to correspond with four fastener openings 18 defined in the connector plate 11 wherein each fastener opening is positioned in a respective one of the four corners of the connector plate. The overlapping groups of fastener openings can then be transfixed by fasteners to secure the plates to the panel. The mounting panel further includes a pair of end flanges 30 that extend laterally outwards from the sides of the mounting panel and each includes a pair of fastener openings 31 for mounting the panel 10 to a rack, frame, bulkhead or other support.

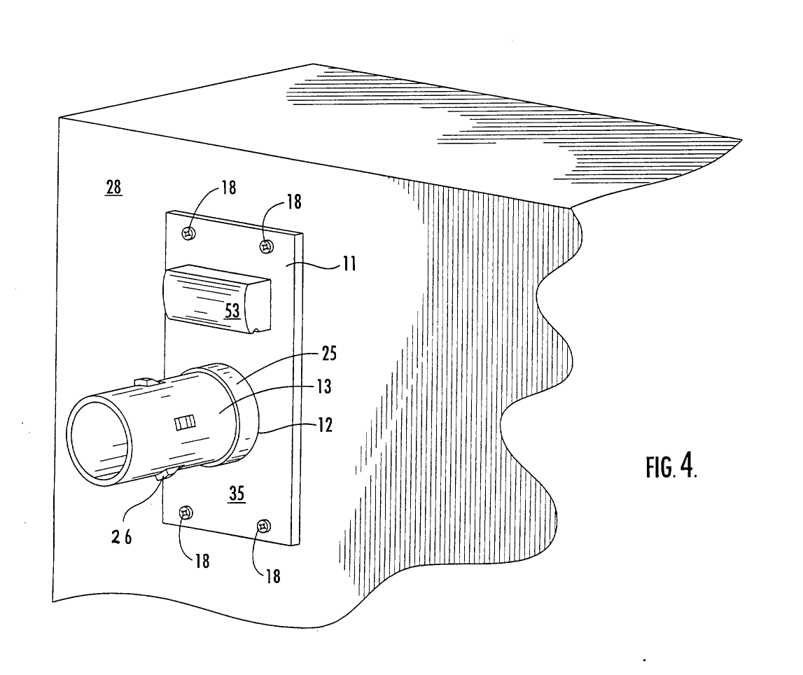

Although the mounting locations are shown as being distributed evenly over a horizontal direction, the groups of fastener openings can be allocated, as desired on different surfaces and locations of the mounting panel 10, to change the number, positioning, orientation and organization of the connector plates and connectors held by the mounting panel. Further, variations on the connector mounting panel 10 dimensions and material construction are possible and still within the scope of the present invention, such as variations in the height, width and thickness of the mounting panel material depending upon the desired combination of connectors and support plates, and therefore the configuration of the illustrated embodiment should not be considered limiting. In fact, the connector mounting panel 10 may be excluded entirely in favor of a connector plate 11 having multiple connector openings that are directly attachable to a bulkhead, as illustrated in an alternative embodiment in FIG. 4, or even a bulkhead 28 having connector openings defined directly therein for receipt of the connectors 13, 14.

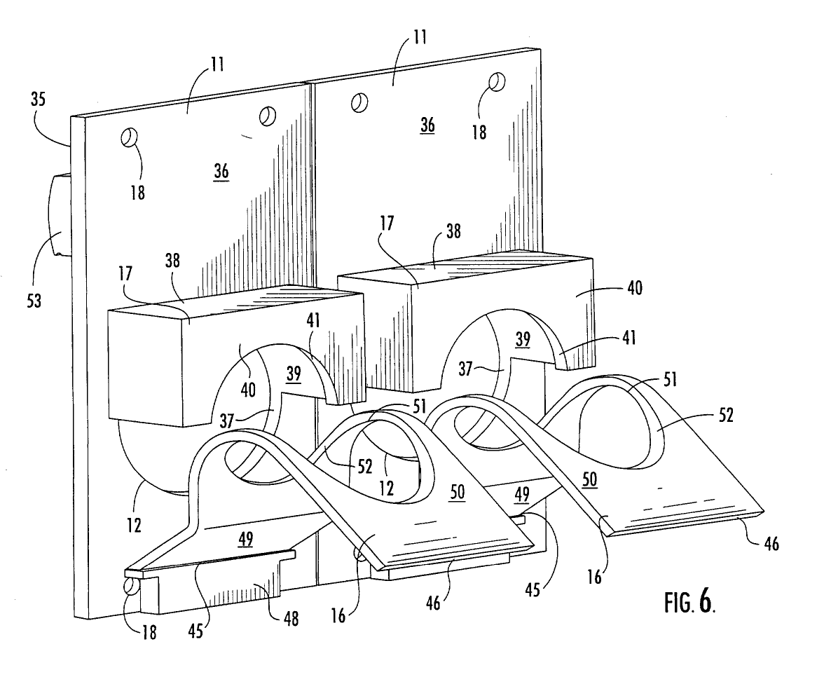

The connector plate 11 includes a front face 35 and a back face 36 wherein the connector opening 12 extends between the faces, as best shown in FIGS. 5 and 6. Preferably, the connector opening has a circular shape to correspond to the right-cylindrical shape of the connector body 23 or 24. A portion of a surface 37 of the connector plate 11 that defines the periphery of the connector opening 12 provides support for the connector body wherein the connector body abuts the support surface portion when positioned in the connector opening. The connector opening 12 may have other shapes, such as a square, triangular, or irregular shape, that is congruent, or is non-congruent with respect to the shape of the connectors, as long as some support surface is defined generally opposite the spring clip 16 on the other side of a mounted connector. In this manner, the support surface can still abut the connector body being urged against it so as to hold the connector. However, it should be noted that a congruent shape of the illustrated connector opening 12 generally provides a larger supporting portion of the surface 37.

In the illustrated embodiment, the support portion of the surface 37 is extended outwards away from the back face 36, in an axial direction with respect to the connector, by a base portion 38 of the retaining member 17. The base portion 38 is several times the thickness of the connector plate, has flat top and side surfaces and defines a semicircular surface 39 that has the same shape as, and is aligned with, the support portion of the support surface 37. The semicircular support surface provides additional support for the abutting connector body 23 or 24 and serves to prevent the connector from tilting when bias is applied by the spring clip 16. In addition, the base portion 38 serves as a support for a top portion 40 of the retaining member which defines a retaining edge 41, as will be described in more detail below. Advantageously, in the illustrated embodiment the portion of the surface 37 on the same side of the connector as the spring clip 16 will restrain tilting because of its congruency to the connector 13 or 14's shape.

It should be noted that support members other than the connector plate 11 with its connector opening 12 could be used to provide a support surface against which the spring clip 16 urges the connector 13 or 14. For instance, a rack having a pair of spaced, parallel rack members could be used wherein a series of cradle-shaped members, akin to the base portion 38 of the retaining member 17, but without the support plates 11, could be supported on one rack member each in a position corresponding to a respective spring clip 16 on the opposite rack member. It should also be noted that the connector plate 11 could have differently angled front and back faces 35, 36 for angled mounting of connectors 13, 14. Further, the connector plate 11 may include a designation strip mount 53 upon which a label may be affixed to indicate the device to which the triaxial cable 15 is connected.

The retaining edge 41 also has a semicircular shape, but of a circle having a smaller diameter than the connector opening 12 and base portion support surface 39. The smaller diameter causes the retaining edge 41 to extend inwards towards the connector further than the support surface 39. The male and female connectors 13, 14 each have a groove 27 that extends around its circumference and is sized to receive the retaining edge 41. Each groove 27 has a pair of spaced shoulders which abut opposite sides of the retaining edge 41 when the connector is urged onto the support surfaces 37, 39 and the retaining edge by the spring clip 16. Such an abutting arrangement inhibits axial movement of the connector in both directions. Alternatively, only a single shoulder could be provided to selectively limit axial motion in only one direction.

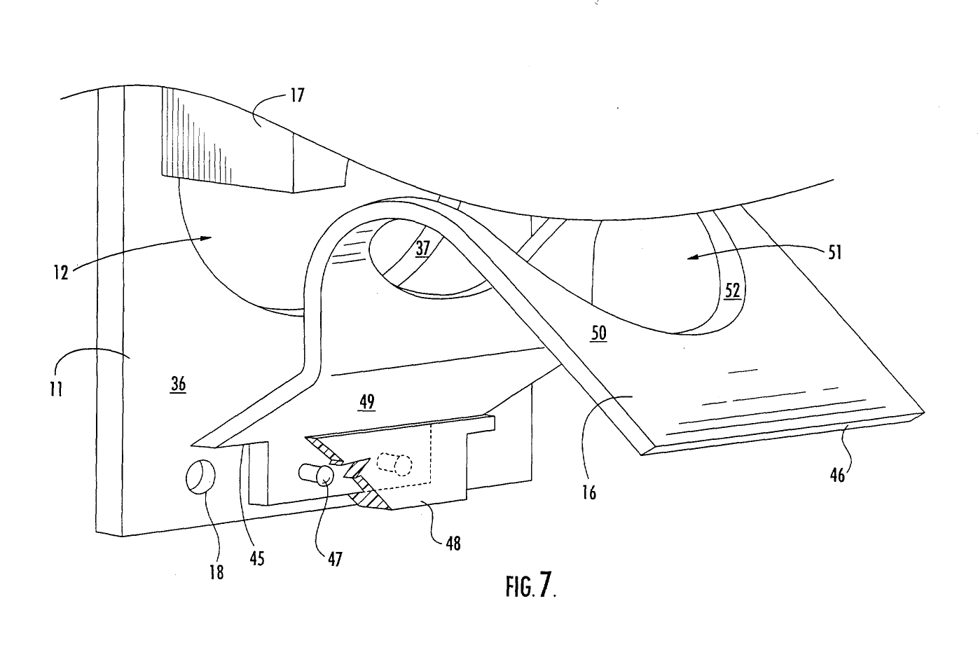

The spring clip 16 includes a fixed end 45 and a free end 46. The fixed end is attached to the connector plate 11 by being overmolded into the connector plate during its creation, as shown in FIG. 7. Preferably, the connector plate is constructed of a plastic or polymeric material that is dispensed into a mould having a shape complementary to the connector plate and in which the fixed end 45 of the spring clip 16 is suspended. For further reinforcement, the fixed end may be transfixed by several connector studs 47 that provide a greater surface area for adherence of the overmolded plastic material. Overmolding of the plastic material results in a thickened, rectangular block 48 along a bottom edge of the connector plate.

Preferably, the spring clip 16 is constructed of a cantilevered, spring-steel ribbon that has a flat bottom portion 49 and an arc-shaped top portion 50. The flat bottom portion 49 extends upwards and slightly inwards toward the connector opening 12. The top portion 50 extends from the bottom portion 49 inwards towards the connector opening 12 nearly parallel to the back face 36 of the connector plate and then flares outwards away from the connector opening as it extends upwards to its free end 16. The top portion 50 defines an elliptical opening 51 that, due to the arc shape of the ribbon, forms a clevis with a semicircular profile when viewed from a perspective aligned with the axis of the triaxial connector being inserted therein. The edges of the spring clip that define the elliptical opening 51 form a surface 52 that is generally parallel to, and abuts, the outer surface of the connector 13, 14 inserted between the clip and the retaining member 17. At the surface 52, the spring clip exerts a bias on the connector, thereby urging it against the support surfaces 37, 39 and the retaining edge 41.

Other spring-biased devices may be used in lieu of the spring clip 16 for exerting a bias on the connector wherein the alternative devices provide a spring-biased surface generally opposite a support surface so that the spring-biased surface urges the connector against a support surface. Alternative spring-biased members, for example, could include a plastic cantilevered member extending from the connector plate, or a non-cantilevered coil spring extending between the connector plate 11 and an outside surface of the connector. It should also be noted that other materials could be used for the connector plate, such as a steel sheet similar to that of the spring clip 16, wherein the steel sheet is punched to form the connector opening 12 and the spring clip simultaneously.

Although alternatives are available, the cantilever configuration of the illustrated spring clip 16 allows for easy insertion and removal of the connectors 13, 14 from the connector mounting panel 10 without the use of fasteners. When an equipment operator needs to secure the end of a triaxial cable, the male or female connector 13, 14 is advanced towards to the back face 36 of the connector plate 11 and the free end 46 of the spring clip 16 is retracted away from the retaining member 17. Advantageously, the free end 46 has a tab shape that is easily gripped by the operator's thumb for retraction. Alternatively, the operator may rely on the flared shape of the top portion 50 to cause the top portion to be urged outwards against its bias by the end of the advancing connector 13, 14.

Retraction of the spring clip 16 widens the spacing between the spring clip and the retaining member 17, allowing the connector to slide therebetween along the spring-biased surface 52 and the retaining edge 41. Further advancement extends the triaxial connector through the connector opening 12 in the connector plate 11. Once the connector 13 or 14 is advanced a sufficient further distance, its circular groove 27 is positioned subjacent the retaining edge 41 and the retaining edge is urged into the circular groove, adjacent the shoulders of the groove, by the bias of the spring clip 16. As the retaining edge 41 snaps into the circular groove, the male or female body 23, 24 is urged into abutting contact with the connector plate 11 and base portion support surfaces 37, 39 for additional support, as shown in FIG. 1.

When removal of the connector 13 or 14 is desired, the above-described process is reversed. The spring clip 16 is retracted away from the connector 13 or 14 by grasping and pulling its free end 46. The connector is moved away from the retaining edge 41 of the retaining member 17 until the retaining edge no longer abuts the shoulders of the circular groove 27. Once the retaining edge 41 clears the groove 27 on the connector 13 or 14, the connector may be retracted backwards, its end exiting the connector opening 12 and its outer surfaces sliding over the retaining edge and the spring-biased surface 52 of the spring clip 16.

The present invention has many advantages. For instance, the connector mounting assembly is easy and quick to use because the spring clip 16 is retractable to allow insertion and removal of the connectors 13, 14 without the removal and reattachment of fasteners. The retaining member 17 limits axial movement of the connectors via the retaining edge 41 being adjacent the shoulder of the groove 27 on the connectors. Also, the retaining member provides additional support through its base portion support surface 39 which abuts the connector outer surface along with the support surface 39 of the connector plate 11. The congruent, circular shape of the connector opening 12 further restricts movement of the connector 13 or 14 through increased surface area contact with the right cylindrical surface of the connector. Also, the portion of the surface 37 on the same side of the connector as the spring clip 16 inhibits tilting of the connector under the application of the spring bias. Overmolding the fixed end 45 of the spring clip 16, and the use of connector studs 47, provides a secure connection of the spring clip to the connector plate 11. The length of the elliptical opening 51 provides a relatively elongate spring-biased surface 52 for firm, abutting support of the connector against the retaining member 17 and the support surfaces 37, 39.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A connector mounting assembly for receiving and holding a connector at an end of a conducting cable wherein the connector has an outer surface, said mounting assembly comprising:
a support member defining at least one support surface configured to abut the outer surface of the connector; and
a spring-biased device defining at least one spring-biased surface, wherein the spring-biased surface is positioned opposite the support surface and the spring-biased device is spaced a sufficient distance from the support member to allow the connector to pass between the support member and spring-biased device and wherein the spring-biased surface is configured to urge the connector against the support surface so as to inhibit movement of the connector.

2. A connector mounting assembly of claim 1, further comprising a retaining member defining a retaining edge configured to abut a shoulder of the connector, wherein the retaining member is positioned opposite the spring-biased device and said retaining edge is spaced a sufficient distance from the spring-biased device to allow the connector to pass between the retaining member and spring-biased device and wherein the spring-biased surface is configured to urge the connector against the retaining edge adjacent the shoulder of the connector.

3. A connector mounting assembly of claim 2, wherein the support member includes a support plate having a front and back faces and defining an opening extending between the front and back faces sized to pass the connector therethrough and wherein said opening is at least partially defined by the support surface.

4. A connector mounting assembly of claim 3, wherein the retaining member is fixed to, and extends from, the back face of the support plate.

5. A connector mounting assembly of claim 4, wherein the support member and the retaining member are integrally formed of a single piece of material.

6. A connector mounting assembly of claim 5, wherein the retaining edge is defined by a radially projecting extension defining a pair of shoulders for engagement in a groove of a connector.

7. A connector mounting assembly of claim 1, wherein the support plate includes a plurality of fastener openings extending between the front and rear surfaces.

8. A connector mounting assembly of claim 1, wherein the spring-biased device is a cantilever spring having a fixed end and is configured to extend from the fixed end along the connector to a free end.

9. A connector mounting assembly of claim 8, wherein the cantilever spring-biased device defines the spring-biased surface as being at least partially congruent to a right-cylindrical surface of the connector.

10. A connector mounting assembly of claim 9, wherein the support surface is defined by the support member as being at least partially congruent to the right-cylindrical surface of the connector

11. A connector mounting assembly of claim 10, wherein the fixed end of the cantilever spring-biased device is fixed to the support member.

12. A connector mounting assembly of claim 11, wherein the cantilever spring is constructed of a ribbon of resilient material that extends in an arc from the fixed end to the free end and wherein the spring-biased surface defines an elliptical opening in the resilient material ribbon.

13. A connector mounting assembly of claim 12, further comprising a retaining member defining a retaining edge configured to abut a shoulder of the connector, wherein the retaining member is positioned opposite the spring-biased device and said retaining edge is spaced a sufficient distance from the spring-biased device to allow the connector to pass therebetween and wherein the spring-biased surface is configured to urge the connector against the retaining edge adjacent the shoulder of the connector.

14. A connector of claim 13, wherein the retaining edge is defined by a radially projecting extension defining a pair of shoulders for engagement in a groove of a connector.

15. A connector of claim 8, wherein the fixed end of the cantilever spring-biased device is overmolded to the support member.

16. A connector of claim 15, wherein the fixed end of the cantilever spring-biased device is further secured within the overmolding by a plurality of connector studs.

17. A method of securing a connector at the end of a conducting cable wherein the connector has an outer surface, said securing method comprising:
retracting a spring-biased surface of a spring biased device away from a support surface of a support member;
advancing the connector into a position between the spring-biased surface and the support surface;
releasing the spring-biased surface into abutting contact with the outer surface of the connector; and
urging the connector against the support member into abutting contact with the support surface so as to secure the connector between the surfaces.

18. A securing method of claim 17, wherein urging the connector includes urging a shoulder into abutting contact with a retaining edge of the support member.

19. A securing method of claim 17, further comprising retracting the spring-biased surface of the spring biased device away from the connector and retracting the connector from between the spring-biased surface and the support surface.

20. A securing method of claim 17, wherein advancing the connector includes advancing an end of the connector through an opening defined in the support member.
